(19) United States
(12) Patent Application Publication
(10) Pub. No.: US 2026/0180121 A1
(43) Pub. Date: Jun. 25, 2026

(54) MANAGEMENT OF THERMAL EVENT BY-PRODUCTS IN A BATTERY PACK

(71) Applicant: Toyotta Motor Engineering & Manufacturing North America, Inc., Plano, TX (US)

(72) Inventors: David Richard Eilken, Ann Arbor, MI (US); Ayrton Ackerman, Ann Arbor, MI (US)

(73) Assignees: Tyota Motor Engineering & Manufacturing North America, Inc., Plano, TX (US); Toyota Jidosha Kabushiki Kaisha, Toyota-shi (JP)

(21) Appl. No.: 18/987,832

(22) Filed: Dec. 19, 2024

(51) Int. Cl. H01M 50/383; B60L 50/64; H01M 50/209; H01M 50/271; H01M 50/289; H01M 50/342

(52) U.S. Cl. CPC H01M 50/383; B60L 50/64; H01M 50/209; H01M 50/271; H01M 50/289; H01M 50/3425; H01M 2220/20

(57) ABSTRACT

An intermediate cover for a battery pack includes a frame defining a plurality of openings, and a plurality of caps attached to the frame. Each cap is positioned and structured to removably close an associated frame opening. Each opening is arranged to overlie an associated housing cavity of the battery housing when the intermediate cover is attached to the housing. Upon initiation of a thermal event in one of the housing cavities, a cap removably closing an intermediate cover opening associated with the cavity may detach from the remainder of the cover, allowing thermal event by-products to exit from the cavity, while caps covering other openings and housing cavities remain in place, thereby protecting undamaged battery cells/modules from the escaping thermal event by-products. An electric vehicle battery system including the intermediate cover and a method for limiting exposure of a battery module to thermal event by-products are also disclosed.

### TECHNICAL FIELD

The present disclosure relates to a cover for a battery system, and more particularly to an intermediate cover mounted in a battery pack between a main battery pack cover and a battery pack housing containing battery cells and/or modules.

### BACKGROUND

It is well-known to use electric battery packs for powering electric vehicles (EV's). A battery pack may include a housing having an interior divided by walls into multiple cavities. Multiple battery cells or a battery module may be received in each housing cavity. A thermal event (e.g., “thermal runaway” caused by an uncontrollable increase in battery cell temperature) may occur in a battery or module located in a housing cavity. The thermal event generates by-products such as hot gases and particulates. If undamaged battery cells and/or modules are exposed to these by-products, the thermal event may propagate to other portions of the battery pack, potentially causing destruction of the battery pack.

### SUMMARY

In one aspect of the embodiments described herein, an intermediate cover for a battery pack is provided. The intermediate cover includes a frame defining a plurality of openings, and a plurality of caps attached to the frame, each cap being positioned and structured to removably close an associated opening of the plurality of openings.

In another aspect of the embodiments described herein, an electric vehicle battery system is provided. The battery system includes a battery pack housing, a battery pack main cover, and an intermediate cover attached to the battery pack housing between the housing and the main cover.

In yet another aspect of the embodiments described herein, a method is provided in a battery system for limiting exposure of a battery module to thermal event by-products. The method includes a step of attaching an intermediate cover to a battery pack housing of the battery system to individually removably close each housing cavity of the battery pack housing.

### BRIEF DESCRIPTION OF THE DRAWINGS

The accompanying drawings, which are incorporated in and constitute a part of the specification, illustrate various systems, methods, and other embodiments of the disclosure. In some embodiments, one element may be designed as multiple elements or multiple elements may be designed as one element. Furthermore, elements may not be drawn to scale. Also, unless otherwise stated or shown, the same or similar elements shown in different views may be given the same or similar reference numerals or designations.

FIG. 1 is a schematic side view of a vehicle including a battery pack incorporating an intermediate cover in accordance with an embodiment described herein.

FIG. 2 is an exploded perspective view of battery pack incorporating an intermediate cover in accordance with an embodiment described herein.

FIG. 3 is a schematic cross-sectional side view of a portion of the battery pack of FIG. 2, showing an intermediate cover in accordance with an embodiment described herein attached to a battery pack housing prior to initiation of a thermal event in a battery cell/module located in a cavity of the housing.

FIG. 4A is a schematic exploded perspective view of an intermediate cover in accordance with an embodiment described herein.

FIG. 4B is a schematic cross-sectional side view of a portion of the intermediate cover shown in FIG. 3.

FIG. 4C is a magnified schematic cross-sectional side view of a portion of FIG. 4B, showing portions of a cap attached to a frame of the intermediate cover by clamps.

FIG. 4D is a schematic plan view of the assembled intermediate cover shown in FIG. 2.

FIG. 5 is the schematic cross-sectional side view of FIG. 3, showing the intermediate cover after initiation of a thermal event in a battery cell/module located in a cavity of the housing, and detachment of a cap covering the housing cavity.

FIG. 5A is the schematic cross-sectional side view of FIG. 5 illustrating a case where a cap only partially separates from the frame of the intermediate cover following initiation of a thermal event.

FIG. 6 is a magnified schematic cross-sectional side view similar to FIG. 4B, showing an alternative embodiment of a clamp for securing a cap to the frame of the intermediate cover.

### DETAILED DESCRIPTION

The present disclosure is directed to an intermediate cover for a battery pack. The intermediate cover may be positioned between a housing containing battery cells and/or modules, and a main cover of the battery pack. The intermediate cover may include a frame defining a plurality of openings, and a plurality of caps attached to the frame. Each cap may be positioned and structured to removably close an associated opening of the plurality of openings. Each frame opening of the intermediate cover may be arranged to overlie an associated housing cavity of the battery housing when the intermediate cover is attached to the housing. Each housing cavity may contain associated battery cells/modules. The intermediate cover may be structured and attached to the housing so as to environmentally isolate individual housing cavities from each other. Upon initiation of a thermal event in one of the housing cavities, a cap removably closing an intermediate cover opening associated with the cavity may detach from the remainder of the cover, allowing thermal event by-products to exit from the cavity. However, caps removably closing other openings and housing cavities containing undamaged cells/modules remain in place, thereby protecting the undamaged cells/modules from the escaping thermal event by-products. An electric vehicle battery system including the intermediate cover and a method for limiting exposure of a battery module to thermal event by-products are also disclosed.

As used herein, the term “upper” refers to a vertically relatively higher position or location, and “lower” refers to a vertically relatively lower position or location, from the perspective of a person standing adjacent a vehicle resting on a ground surface and including a battery pack as described herein mounted in the vehicle in an end-use configuration of the battery pack. also, a feature of the invention is considered to reside “above” another feature when the feature is positioned vertically higher than the other feature, from the perspective of a person standing adjacent a vehicle resting on a ground surface and including a battery pack as described herein mounted in the vehicle in an end-use configuration of the battery pack. also, a feature of the invention is considered to reside “below” another feature when the feature is positioned vertically higher than the other feature, from the perspective of a person standing adjacent a vehicle resting on a ground surface and including a battery pack as described herein mounted in the vehicle in an end-use configuration of the battery pack.

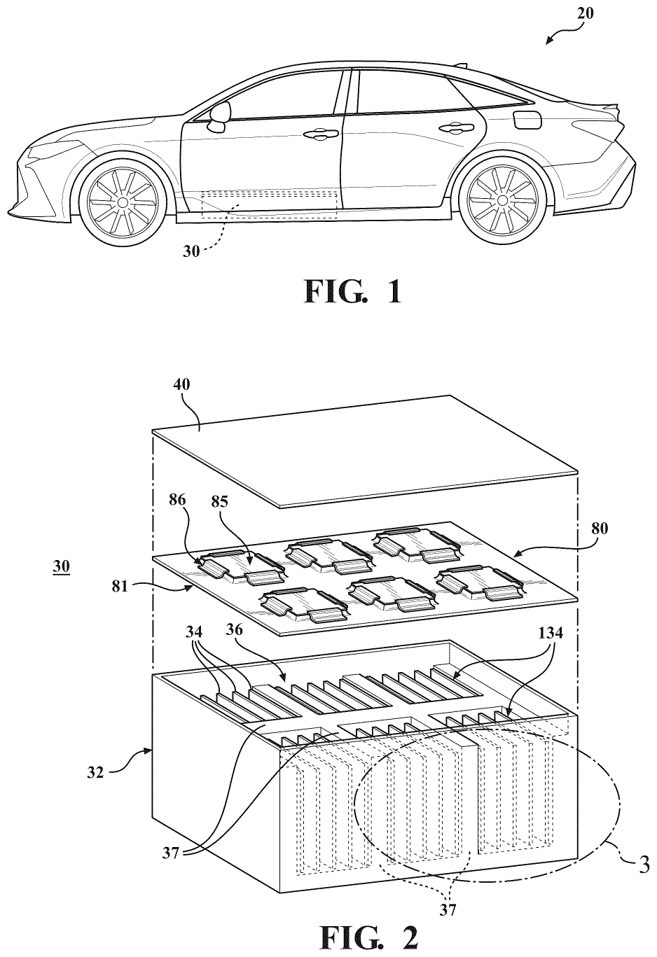

FIG. 1 is a schematic side view of an electric vehicle 20 incorporating a battery pack 30 in accordance with an embodiment described herein mounted in the vehicle 20. The battery pack 30 may be part of a battery system including additional known elements such as an on-board charger (OBC), a battery cooling system, electronic control unit (ECU), power electronics and other elements (not shown) configured for controlling operation of the battery pack 30 and integrating the battery pack with other vehicle systems. In one or more arrangements, the vehicle 20 may be an electric vehicle (EV) and the battery system may be configured to power operation of the electric vehicle.

FIG. 2 is a schematic exploded perspective view of battery pack 30 incorporating an intermediate cover 80 in accordance with an embodiment described herein. The battery pack 30 is a collection of individual battery cells (such as cells 34) and/or battery modules (such as modules 134) arranged in a specific configuration to provide a unified power source. These cells and/or modules may be electrically interconnected in series or parallel configurations and arranged within a protective housing 32 to help ensure safe and efficient operation. The arrangement of cells and/or modules within the battery pack 30 may be designed to optimize performance, capacity, and voltage output for the intended application, so as to deliver reliable and consistent power supply to the other vehicle systems.

In some arrangements, the battery pack 30 integrates components such as battery management systems (BMS), thermal management systems, and safety features (not shown in FIG. 2) to provide a complete power solution for a specific application. Battery packs are commonly used in electric vehicles, energy storage systems, and portable electronics, offering higher voltage, capacity, and energy density than individual battery cells or modules.

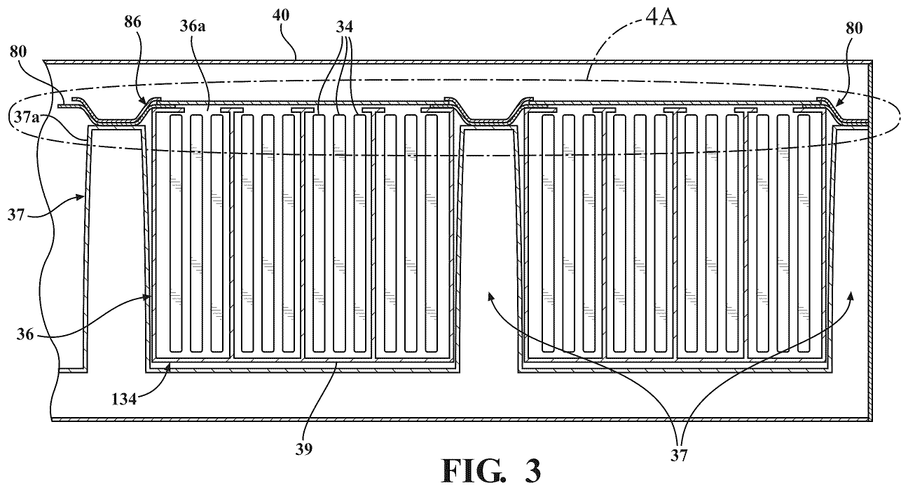

Referring to FIGS. 2 and 3, the battery pack 30 may include housing 32 which is structured to facilitate storage, arrangement, connection, and/or operation of the battery cells 34 and/or modules 134. The housing 32 may include discrete cavities 36 formed therein, with housing walls 37 separating adjacent ones of cavities 36. The cavities 36 may be structured to receive therein the battery cells 34 and/or modules 134 of the battery pack 30. The housing walls 37 may be structured to provide structural support to the battery cells/modules 34/134. The housing walls 37 may also be structured to help environmentally isolate the battery cells contained in each cavity, to aid in preventing by-products of a thermal event occurring in one housing cavity from propagating to battery cells/modules located in one or more other housing cavities.

Referring to FIG. 3, each housing cavity 36 may have an associated opening 36a defined by intersecting uppermost portions 37a of the housing walls 37. The housing 32 may be formed from metallic materials, polymers and/or any other materials suitable for the purposes described herein.

The housing embodiment 32 shown in the drawings includes six housing cavities 36, with each cavity structured to receive therein an associated battery module 134 or an associated grouping of individual battery cells 34. The terms “housing cavity”, “module cavity” and “battery cavity” will be used interchangeably herein to describe a cavity formed in the battery pack housing and structured to receive and store therein a battery module 134 or a grouping of individual battery cells 34.

Referring to the drawings, the battery pack 30 may include a plurality of battery cells 34 arranged in each housing cavity, either individually or as a module 134. The battery cells 34 may be lithium-ion battery cells or other types of battery cells. In some arrangements, the individual battery cells 34 may have prismatic or flat shapes as shown in the drawings. Alternatively, the individual battery cells 34 may be cylindrical or have a known pouch design.

As shown in the drawings, each housing cavity may 36 be structured to receive and contain therein multiple battery cells 34. In some arrangements, the multiple battery cells 34 may be arranged into one or more self-contained battery modules 134. For purposes described herein, a “battery module” is a collection of interconnected battery cells 34 that is positioned within a single cavity 36 of the battery pack housing 32. For example, a grouping of battery cells 34 may be arranged in a module casing 39 structured to contain the battery cells and to be positionable inside an associated cavity 36 in the battery pack housing 32. This enables a group of battery cells 34 to be replaced by extracting the module casing 39 containing the battery cells 34 from the housing cavity 36. The modules 134 can thus be easily replaced or upgraded in the battery pack 30, offering flexibility and scalability in capacity and configuration. The casing 39 may be formed from metallic, polymeric and/or other suitable materials.

To enable and facilitate operation and control of the battery module, each module 134 may also include other elements and/or sub-systems besides the battery cells 34 (e.g., a cooling system, voltage monitoring circuits, etc.) not shown in the drawings. A battery pack 30 may include a plurality of battery modules 134. The battery pack 30 shown in the drawings includes six battery modules 134 which may be electrically coupled in series, parallel, or a combination thereof to power portions of the vehicle 20.

Referring to FIGS. 2 and 3, the battery pack 30 may include a main cover 40. The main cover 40 may be attachable to the battery pack housing 32 to enclose and protect the battery cells/modules 34/134. The main cover 40 may also be structured to seal the battery pack housing 32 and/or otherwise environmentally isolate the battery pack contents from an exterior of the battery pack when the main cover 40 is secured to the housing 32 in its end use configuration. The main cover 40 may be formed from a metallic material(s) and/or any other suitable materials.

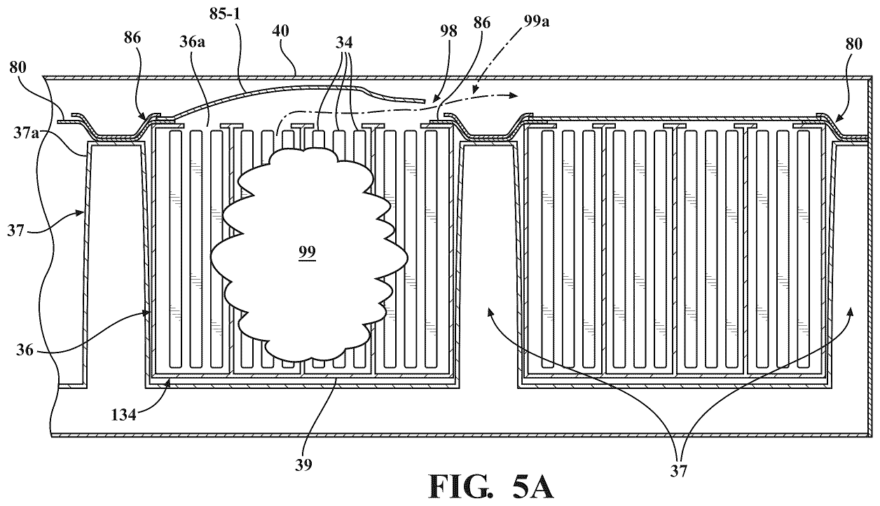

The main cover 40 may (alone or in combination with the housing 32) define one or more vents or openings (not shown) structured to allow thermal event by-products generated inside the battery pack 30 to escape to an exterior of the battery pack. In some arrangements, the by-products may flow in a predetermined direction within the space between the intermediate cover 80 and the main cover 40 after escarping an originating cavity (i.e., a housing cavity where the thermal event occurred). For example, in the example shown in FIG. 5, the battery pack 30 is structured do that thermal event by-products 99a flow in direction R1 toward a vent (not shown) after escaping the housing cavity that was previously removably closed by cap 85-1.

Embodiments of the battery pack described herein also incorporate an intermediate cover, generally designated 80. For purposes described herein, an “intermediate cover” of the battery pack 30 is a cover interposed between the main cover 40 of the battery pack 30 and the battery cells 34 and modules 134 contained cavities 36 of the battery pack housing 32. An “intermediate cover” is also a cover structured to removably close each opening leading 36a into an associated individual battery pack housing cavity 36 when the intermediate cover 80 is mounted on the housing 32 in its end-use configuration. As used herein, the term “mounted on the housing” includes both direct attachment to the housing 32 (i.e., involving direct physical contact between the intermediate cover and the housing), and indirect attachment (i.e., contact through one or more intermediate elements, such as gaskets, spacers, etc. interposed between the intermediate cover and the housing).

With respect to the intermediate cover embodiments described herein, “removable closing” of a housing cavity opening 36a by the intermediate cover refers to prevention of migration of thermal event by-products (in some embodiments, including heat) from an exterior of a housing cavity to a battery and/or battery module residing within the housing cavity, sufficient to cause a thermal event in the battery and/or battery module. Also, “removable closing” of a housing cavity opening by the intermediate cover also refers to the cover enabling venting of thermal event by-products generated in the interior of the housing cavity, from the interior of the housing cavity to an exterior of the housing cavity.

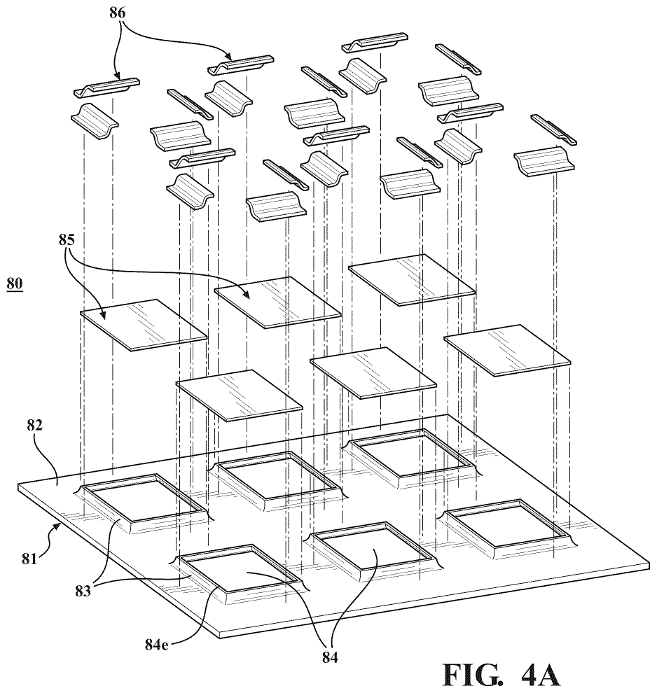

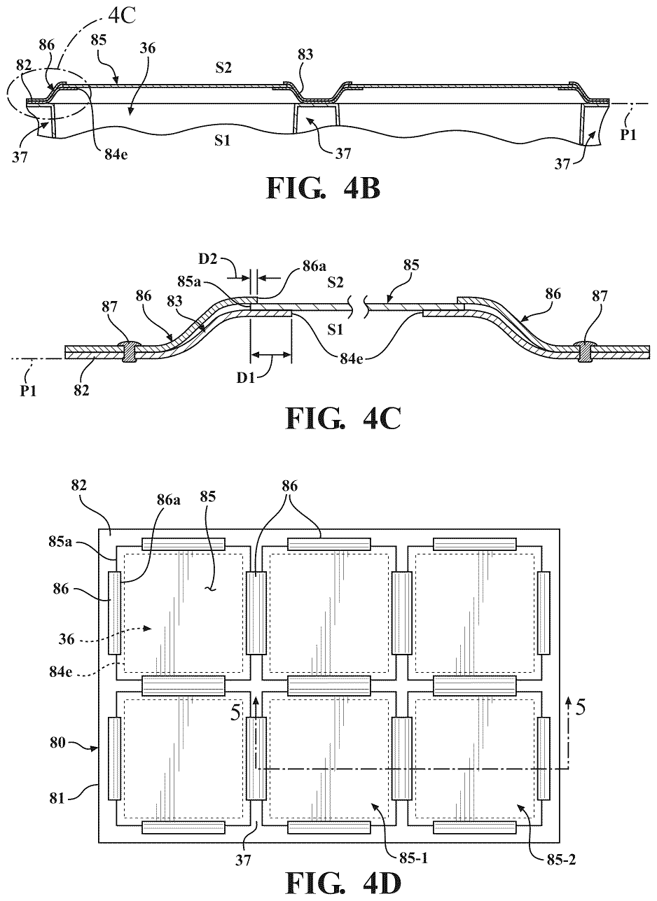

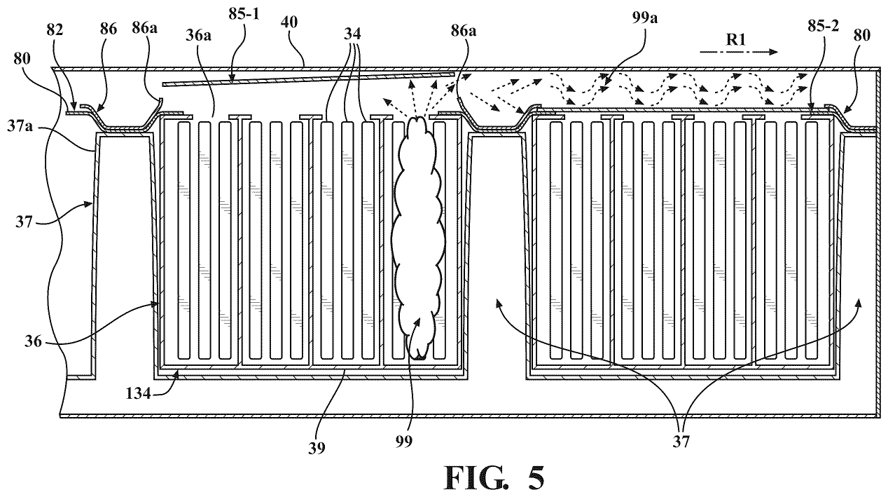

Referring to FIGS. 2-4D, in one or more arrangements, the intermediate cover 80 includes a frame 81 that is attachable to the housing 32. The frame 81 may include a base portion 82. The base portion 82 may define a flat plane P1 including portions of the intermediate cover 80 that are attachable to the battery pack housing 32. Referring to FIGS. 3 and 4B, the frame base portion 82 may be structured to be attachable to the housing 32 along upper portions 37a of the housing walls 37 so as to form respective seals between the housing walls 37 and the frame base portion 82 when the intermediate cover 80 is attached to the housing 32 in its end-use configuration. This may aid in environmentally isolating adjacent housing cavities 36 from each other. As used herein, for first and second housing cavities separated by a housing wall, “environmental isolation” refers to structuring of the housing wall, the portion of the intermediate cover attached to the housing wall, and/or the junction between the intermediate cover and the housing wall so as to prevent migration of thermal event by-products from the first housing cavity to the second housing cavity sufficient to trigger a thermal event in the second housing cavity.

Referring to FIG. 4A, the frame 81 may define a plurality of openings 84 extending therethrough. The frame 81 may be structured so that each frame opening 84 resides above an associated individual cavity 36 of the battery pack housing 32 when the frame 81 is attached to the housing 32 in an end-use configuration of the intermediate cover 80. Each frame opening 84 has one or more associated edges 84e.

Referring to FIGS. 4A-4C, in some arrangements, frame 81 may include a plurality of extended portions 83 extending from the base portion 82. In the arrangement shown in FIGS. 4A-4C, each extended portion 83 includes at least one associated opening 84 of the plurality of openings. The extended portions 83 of the frame 81 may be structured to extend upwardly from the base portion 82 and out of plane P1 when the intermediate cover 80 is mounted on battery pack housing 32 and the battery pack 30 is mounted in its end-use configuration in a vehicle.

Referring to FIGS. 4A-4D, in one or more arrangements, removable closure of the housing cavity openings 36a is provided by a plurality of caps 85 incorporated into the intermediate cover. The caps 85 may be formed separately from the frame 81 and attached to the frame 81, with each cap 85 being positioned and structured to removably close an associated opening 84 of the plurality of openings.

With regard to the intermediate cover embodiments shown in FIGS. 4A-6, “removable closing” of an opening 84 formed in a frame 81 of the intermediate cover 80 and overlying an associated housing cavity opening 36a refers to closing of the frame opening 84 such that the portions of the intermediate cover 80 closing the opening (e.g., a “cap 85” and/or a clamp 86 as described in greater detail below) are structured to facilitate complete physical separation of the cap from a remainder of the intermediate cover 80 responsive to a thermal event occurring in a battery module located along a first side S1 of the frame opening 84 (i.e., to a thermal event occurring in the individual housing cavity 36 residing beneath the frame opening 84) when the intermediate cover 80 is mounted on the battery pack housing 32 in an end-use configuration of the intermediate cover. This enables the escape of by-products generated by a thermal event occurring inside the housing cavity 36, from an interior of the housing cavity through housing cavity opening 36a and the intermediate cover 80, to an exterior of the housing cavity. Also, with regard to the intermediate cover embodiments shown in FIGS. 4A-6, removable closing” of an opening 84 formed in a frame 81 of the intermediate cover 80 and overlying an associated housing cavity opening 36a refers to prevention of migration of thermal event by-products from an exterior of a housing cavity 36 residing beneath the frame opening (i.e., from a second side S2 of the frame opening) into an interior of the housing cavity 36 (i.e., to a first side S1 of the frame opening 84), to the degree necessary to prevent initiation of a thermal event in a battery or module located in the housing cavity interior, when the intermediate cover 80 is mounted on the housing 32. The second side S2 of the opening 84 may be opposite the first side S1 of the opening. Thus, embodiments of the intermediate cover described herein may permit venting of by-products from an affected individual housing cavity to an exterior of the cavity, while simultaneously maintaining removable closure of other cavities containing undamaged batteries and/or modules. In one or more arrangements, the vented thermal event by-products may flow through the battery pack between the intermediate cover 80 and the main cover 40 to one or more battery pack vents (not shown) leading to an exterior of the battery pack 30.

Referring to FIGS. 4A-4D, in one or more arrangements, each cap 85 is formed separately from the frame 81 and attached to the frame 81 so that the cap is physically completely separable from the frame 81 responsive to exposure of the cap 85 along a first side S1 of the cap to thermal event by-products generated in a housing cavity 36 positioned below by the cap 85. As used herein, “physically completely separable” means that the entirety of the cap is free to move with respect to the frame 81 after separation.

Referring to FIGS. 4A-6, in particular arrangements, removable closure of the frame openings 84 is provided by structuring the caps 85 to overlap associated openings 84 formed in the frame extended portions 83. All of the edges 84e of each frame opening 84 may be overlapped to some degree by an associated cap 85 when the cap removably closes the opening 84.

The exemplary intermediate cover 80 shown in FIGS. 4A-4D includes rectangular openings 84 and rectangular caps 85, with each rectangular cap 85 structured to overlap all of the edges 84e of an associated opening 84 when the cap 85 is attached to the frame 81 so as to removably close the opening 84. In the example shown, the cap 85 overlaps each edge 84e of the opening by an amount D1 when the cap 85 is positioned symmetrically with respect to its associated opening 84. In addition, the frame extended portions 83 and the caps 85 may be structured so that each cap is in contact with the frame 81 along portions of the frame adjacent the edges 84e of the associated opening 84. The contact between the cap 85 and the frame 81 may be direct physical contact or indirect contact through, for example, a gasket, a layer of adhesive, or another element or substance interposed between the cap 85 and the frame 81 along the edges 84e of the frame opening 84. The contact between the cap 85 and the frame 81 may be as continuous (i.e., uninterrupted) as possible along portions of the frame 81 residing along the entire perimeter of the frame opening 84, so that gaps between the cap 85 and the frame 81 may be substantially eliminated.

Referring to FIGS. 4A-4D, in one or more arrangements, the intermediate cover 80 may include at least one clamp 86 attached to the frame 81 and structured to exert a clamping force on a portion of at least one associated cap 85 to secure the cap in a position removably closing the associated frame opening 84. As seen in FIGS. 4B and 4C, each clamp 86 may be structured to overlap at least a portion of an associated cap 85 when the cap and the clamp are attached to the frame 81. For example, in FIG. 4C, clamp 86 overlaps an associated edge of a cap 85 by a distance D2. The clamp may be attached to the frame using a mechanical fastener (e.g., a rivet 87 as shown in FIG. 4C), adhesives, or by any other suitable method.

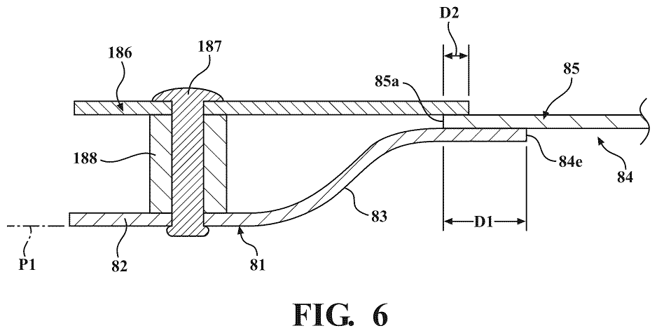

In some arrangements, as seen in FIGS. 4A-4C, clamp 86 is shaped to substantially conform to a shape of an associated extended portion 83 of the frame 81 defining a frame opening 84. Referring to FIG. 6, in alternative arrangements, the clamp 186 is flat and spaced apart from the frame 81 by a spacer 188 when the clamp is connected to the frame 81. The clamp 186 may be attached to the frame 81 using a mechanical fastener (e.g., a rivet 187 applied through the spacer 188 as shown in FIG. 6), adhesives, or by any other suitable method.

In embodiments described herein, the clamps and caps may be structured so that forces exerted by the generated by-products cause any or all of the cap edges to physically separate from the frame either due to deformation of the cap, deformation of one or more clamps, or both.

Operation of the intermediate cover 80 will now be discussed with reference to FIGS. 3 and 5.

FIG. 3 is a schematic cross-sectional side view of a portion of a battery pack showing an intermediate cover in accordance with an embodiment described herein attached to a battery pack housing, prior to initiation of a thermal event in a battery cell/module located in a cavity of the housing. In the event of a battery cell thermal event 99 in which one or more battery cells experience thermal runaway, for example, the battery cells/modules 34/134 may generate thermal event “by-products” 99a including hot gases and solid debris (e.g. particulates) that may damage other, undamaged battery cells and/or modules if exposed to the by-products. FIG. 5 is the cross-sectional side view of FIG. 3 showing separation of a cap from a frame of the intermediate cover after the initiation of a thermal event 99 in a housing cavity positioned below the cap.

The thermal event 99 may produce by-products 99a including expanding hot gases and an associated pressure surge in the housing cavity containing the affected battery cells/module. The elevated pressure may force portions of one or more clamps 86 to bend or deform along portions 86a of the clamps overlapping the cap edge 85a and securing the cap to the frame, to a point where the clamps 86 no longer attach the cap 85-1 to the frame 81. The pressure may then force the cap 85-1 away from the associated housing cavity opening 36a, allowing the thermal event by-products 99a to escape the housing cavity 36 and move along a passage formed between the intermediate cover 80 and the main cover 40 toward a vent (not shown). At the same time, battery cells/modules 34/134 residing in housing cavities located along a flow path of the thermal event by-products 99a (e.g., in the housing cavity covered by cap 85-2) are protected from the by-products 99a by the removable covering affected by associated caps 85 attached to the frame openings 84 residing along the flow path.

FIG. 5A is the view of FIG. 5 adapted to illustrate a case where the cap 85-1 only partially separates from the frame 81 following initiation of the thermal event. After initiation of the thermal event, elevated pressure in the housing cavity 36 may force the cap 85-1 to fold or otherwise deform so that one or more edges of the cap are extracted from between associated clamp(s) and the portion(s) of the frame on which the edge(s) of the cap rested, thereby breaking the physical contact between the edge of the cap and the frame. This enables the thermal event by-products to flow out of the housing cavity through the resulting gap(s) 98.

Although the caps 85 and clamps 86 are structured to facilitate complete detachment of the caps 85 responsive to a thermal event, whether or not an entire cap detaches from the frame 81 may depend on the degree to which the cap and/or associated clamp(s) are deformed by forces exerted by the generated by-products. It has been found that the cap and clamp structures and attachment arrangements described herein facilitate complete detachment of the cap responsive to a thermal event occurring in a housing cavity covered by the cap, while at the same time securing the cap in position against lateral forces exerted by by-products flowing along the second side S2 of the associated frame housing opening. These arrangements also aid in preventing migration of by-products between the cap and the frame, by enabling the clamps to be tightened sufficiently to secure edges of associated caps in intimate contact with portions of the frame adjacent the frame opening. Optimum values of parameters such as the overlap D2 of the clamp edge 86a over the cap edge 85a, the optimum material and material thickness of the clamp 86, and other pertinent parameters needed to ensure reliable venting of the by-products 99a from the housing cavity 36 as described herein may be determined analytically and/or iteratively through experimentation and testing, using methods known or later developed.

In other aspects described herein, a method is provided for limiting exposure of a battery module to thermal event by-products in a battery system. The method includes a step of attaching an intermediate cover to a battery pack housing of the battery system to individually removably close each housing cavity of the battery pack housing.

In the above detailed description, reference is made to the accompanying figures, which form a part hereof. In the figures, similar symbols typically identify similar components, unless context dictates otherwise. The illustrative embodiments described in the detailed description, figures, and claims are not meant to be limiting. Other embodiments may be utilized, and other changes may be made, without departing from the scope of the subject matter presented herein. It will be readily understood that the aspects of the present disclosure, as generally described herein, and illustrated in the figures, can be arranged, substituted, combined, separated, and designed in a wide variety of different configurations, all of which are explicitly contemplated herein.

The terms “a” and “an,” as used herein, are defined as one or more than one. The term “plurality,” as used herein, is defined as two or more than two. The term “another,” as used herein, is defined as at least a second or more. The terms “including” and/or “having,” as used herein, are defined as comprising (i.e. open language). The phrase “at least one of . . . and . . . .” as used herein refers to and encompasses any and all possible combinations of one or more of the associated listed items. As an example, the phrase “at least one of A, B and C” includes A only, B only, C only, or any combination thereof (e.g. AB, AC, BC or ABC).

Aspects herein can be embodied in other forms without departing from the spirit or essential attributes thereof. Accordingly, reference should be made to the following claims, rather than to the foregoing specification, as indicating the scope of the invention.

What is claimed is:

1. An intermediate cover for a battery pack, the intermediate cover comprising:
a frame defining a plurality of openings; and
a plurality of caps attached to the frame, each cap being positioned and structured to removably close an associated opening of the plurality of openings.

2. The intermediate cover of claim 1, wherein each frame opening has one or more edges, and wherein each cap is in contact with the frame along portions of the frame adjacent edges of the associated opening.

3. The intermediate cover of claim 1, wherein each frame opening has one or more edges, and wherein all of the edges of each frame opening are overlapped by an associated cap when the cap removably closes the opening.

4. The intermediate cover of claim 1, wherein the frame is structured so that each frame opening is positioned above an associated cavity of a battery pack housing when the frame is attached to the housing in an end-use configuration of the intermediate cover.

5. The intermediate cover of claim 1, wherein each cap is attached to the frame so that an entirety of the cap is physically separable from the frame responsive to exposure of the cap along a first side of the cap to thermal event by-products generated in a battery pack housing cavity positioned below the cap, when the cap is attached to the frame.

6. The intermediate cover of claim 5, wherein each cap is structured and attached to the frame so as to remain in a position removably closing an associated frame opening responsive to exposure along a second side of the cap opposite the first side of the cap to by-products of a thermal event.

7. The intermediate cover of claim 1, further comprising at least one clamp attached to the frame and structured to exert a clamping force on a portion of an associated cap to secure the cap in a position removably closing the associated frame opening.

8. The intermediate cover of claim 7, wherein the at least one clamp is shaped to substantially conform to a shape of an extended portion of the frame defining the associated frame opening.

9. The intermediate cover of claim 7, wherein the at least one clamp is flat and spaced apart from the frame when the clamp is attached to the frame.

10. The intermediate cover of claim 7, wherein each clamp is structured to overlap at least a portion of an associated cap when the cap and the clamp are attached to the frame.

11. The intermediate cover of claim 1, wherein the frame comprises a base portion and a plurality of extended portions extending from the base portion, each extended portion including at least one associated opening of the plurality of openings.

12. A battery pack comprising an intermediate cover in accordance with claim 1.

13. An electric vehicle battery system, comprising:
a battery pack housing;
a battery pack main cover; and
an intermediate cover attached to the battery pack housing between the housing and the main cover.

14. The electric vehicle battery system of claim 13, wherein the battery pack housing includes individual cavities separated by walls, and wherein the intermediate cover is structured so that the individual cavities are environmentally isolated from each other when the intermediate cover is attached to the housing walls.

15. A vehicle comprising a battery system in accordance with claim 13.

16. In a battery system, a method for limiting exposure of a battery module to thermal event by-products, comprising a step of attaching an intermediate cover to a battery pack housing of the battery system to individually removably close each housing cavity of the battery pack housing.

17. The method of claim 16, wherein the intermediate cover comprises:
a frame defining a plurality of openings; and
a plurality of caps attached to the frame, each cap being positioned and structured to removably close an associated opening of the plurality of openings.

18. The method of claim 17, wherein the frame is structured so that each frame opening is positioned above an associated cavity of the battery pack housing when the frame is attached to the housing in an end-use configuration of the intermediate cover.

19. The method of claim 17, wherein each cap is attached to the frame so that the cap is physically completely separable from the frame responsive to exposure of the cap along a first side of the cap to thermal event by-products generated in a housing cavity positioned below by the cap, when the cap is attached to the frame.

20. The method of claim 17, wherein the frame is structured to be attachable to walls of the housing separating associated cavities of the housing, so as to environmentally isolate adjacent housing cavities from each other.
